(19) United States
(12) Patent Application Publication
(10) Pub. No.: US 2007/0233538 A1
(43) Pub. Date: Oct. 4, 2007

(54) Systems, methods, and apparatus to manage offshore software development

(76) Inventors: Christopher M. Zpevak, St. Louis, MO (US); Richard Plass, Manchester, MO (US); William J. Johnson, St. Louis, MO (US); M. Laverne Ward, Defiance, MO (US); Marcus J. Braunschweig, Eureka, MO (US); Segar Annamalai, Aurora, CO (US)

Correspondence Address: HANLEY, FLIGHT & ZIMMERMAN, LLC, 150 S. WACKER DRIVE, SUITE 2100, CHICAGO, IL, 60606, US

(21) Appl. No.: 11/391,109

(22) Filed: Mar. 28, 2006

(51) Int. Cl. G05B 19/418; G06F 15/02; G06F 17/00; G06F 9/46

(52) U.S. Cl. 705/8; 705/500; 705/9

(57) ABSTRACT

Systems, methods and apparatus are disclosed to manage offshore software development. An example method disclosed herein includes receiving a list of offshore resources for a project, the offshore resources accessible via an offshore module. The example method further includes receiving export laws associated with the project, determining offshore project requirements for the project based on the received export laws, the offshore project requirements compliant with the identified export laws, and communicating the offshore project requirements via the offshore module.

### FIELD OF THE DISCLOSURE

This disclosure relates generally to software development, and, more particularly, to systems, methods, and apparatus to manage offshore software development.

### BACKGROUND

Project management tools and software typically include utilities that allow a user to create a task and/or activity. The user may be a project manager, a project sub-manager, and/or a team member having a degree of project responsibility. The task(s) created by the user typically include a start time/date, an expected task duration, and an end time/date. Additionally, the task entry generally includes detailed task instructions, identifies responsible parties, and identifies other task dependencies.

The project management tools and software also typically provide the user(s) with a high level display of tasks, durations, and critical due dates. Such displays may include one or more Gantt charts, which lay out the order in which tasks need to be carried out. Gantt charts also illustrate task start/finish dates relative to other tasks, and illustrate progress (e.g., % complete) of each task. Because conventional project management tools accommodate a wide and diverse customer base, all tasks, sub-tasks, and various project requirements must be manually developed and entered by the user(s). Each business or organization employing a conventional project management tool or software develops tasks unique to specific needs of that business organization.

Although conventional project management tools and software accommodate a diverse audience, project success, profitability, and efficiency frequently depend upon industry specific knowledge, techniques, and/or best practices. Additionally, failing to address industry specific tasks and/or other unique considerations results in lost opportunities for improved project implementation efficiency.

### BRIEF DESCRIPTION OF THE DRAWINGS

FIG. 1 is a block diagram of an example system to manage offshore software development.

FIG. 2 is a block diagram showing further detail of an example offshore manager of FIG. 1.

FIGS. 3A and 3B are example graphical user interfaces to communicate and manage project testing information for the example system of FIG. 1.

FIG. 4 is an example graphical user interface to communicate and manage project skills information for the example system of FIG. 1.

FIG. 5 is an example graphical user interface to communicate and manage application details information for the example system of FIG. 1.

FIG. 6 is an alternate example graphical user interface to communicate and manage application details information for the example system of FIG. 1.

FIGS. 7A and 7B are example graphical user interfaces to communicate and manage export information for the example system of FIG. 1.

FIG. 8 is an example graphical user interface to communicate and manage vendor resources for the example system of FIG. 1.

FIG. 9 is an example graphical user interface illustrating sample output of the graphical user interface of FIG. 8.

FIG. 10 is an example graphical user interface to invoke functions of the information technology module for the example system of FIG. 1.

FIG. 11A is an example network environment in which the security module may operate.

FIG. 11B is an example graphical user interface to invoke functions of the security module for the example system of FIG. 1.

FIGS. 12A and 12B are flow charts illustrating an example disclosed process to manage offshore software development.

FIG. 13 is a flow chart illustrating an example disclosed process to obtain export law data.

FIG. 14 is a flow chart illustrating an example disclosed process to invoke functions of the security module for the system of FIG. 1.

FIG. 15 is a flow chart illustrating an example disclosed process to invoke functions of the security module for the system of FIG. 1.

FIG. 16 is a schematic illustration of an example computer that may execute the processes of FIGS. 12A, 12B, and 13-15 to implement the example system of FIG. 1.

### DETAILED DESCRIPTION

Systems, methods and apparatus to manage offshore software development are disclosed. An example method includes receiving a list of offshore resources for a project, the offshore resources accessible via an offshore module, receiving export laws associated with the project, determining offshore project requirements for the project based on the received export laws, the offshore project requirements compliant with the received export laws, and communicating the offshore project requirements via the offshore module. An example apparatus includes a business module to identify offshore project objectives, an application team module to establish skill requirements necessary to accomplish the offshore project objectives, a vendor module to identify, select, and track vendors having the necessary skill requirements for the offshore project objectives, and an export module to identify export law constraints.

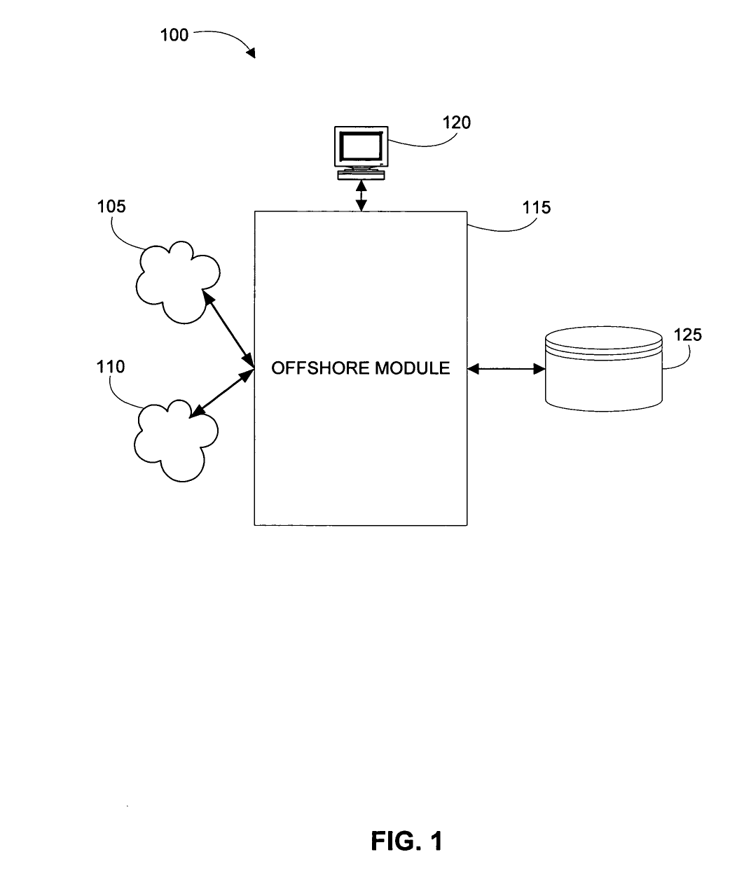

An example system to manage offshore software development 100 is shown in FIG. 1. A project that is “offshore” indicates that resources are separated by a legal and/or regulatory variation. Such offshore resources, such as hardware, software, and/or human workforce resources, may reside in varying cities, counties, states, provinces, continents, and/or countries.

The example system 100 includes at least two remote communication options: the Internet 105 and an intranet 110. The Internet 105 and intranet 110 may be communicatively connected to an offshore module 115. The offshore module 115 may be a system, method, and/or apparatus to manage offshore software development. For example, the offshore module 115 may be a computer program that executes on a workstation and/or server. Users of the offshore module 115 may be located anywhere on the planet and, provided that such users have Internet connectivity and appropriate access credentials, may access the offshore module 115. Similarly, the users may access the offshore module 115 by virtue of their membership to an intranet 110, i.e., a network connecting a set of client devices (e.g., computers, kiosks, workstations, servers, PDAs, etc.). The intranet 110 typically resides behind a firewall, or behind several firewalls connected by secure and/or virtual networks. Only members of the organization that owns the intranet 110 (e.g., employees, authorized vendors, contractors, etc.) are permitted access to the offshore module 115. Additionally, a workstation 120 may also be communicatively connected directly to the offshore module 115. For example, the workstation 120 (or server) may be executing software that facilitates the offshore module 115. The offshore module 115 is also communicatively connected to an offshore database 125, as will be discussed in further detail below. Similarly, the offshore database 125 is typically located proximate the offshore module 115, but may be located in any alternate location without restriction. Redundant databases may also be employed to increase system robustness and data safety.

The offshore module 115 is typically located and/or operating in a host country (e.g., the United States of America) and users may access the offshore module 115 from anywhere on the planet. For example, a business manager (e.g., corporate manager, CEO, etc.) may face cost prohibitive restrictions for developing software in the United States and seek cost judicious alternatives. As a result, the business manager may focus on securing skilled software development resources (e.g., software developers, engineers, information technology specialists, etc.) in other countries that offer such skills and/or services at rates substantially lower than can be acquired in the United States.

As will be discussed in further detail below, the offshore module 115 provides various interactive and dynamic functionality for the user(s). The module may be used to manage offshore project implementation, growth, and management of all required actions and setup for the project at both a high level and low level (detailed) management view. Such functionality may be provided to the users via a web browser and the offshore module 115 may employ a web server to service user requests. The user requests may be serviced by the web server via Active Server Pages (ASP), JavaScript, common gateway interface (CGI), and/or extensible markup language (XML). Such dynamic web page creation and interaction with a database are well known to persons of ordinary skill in the relevant art and, as such, outside the scope of this disclosure.

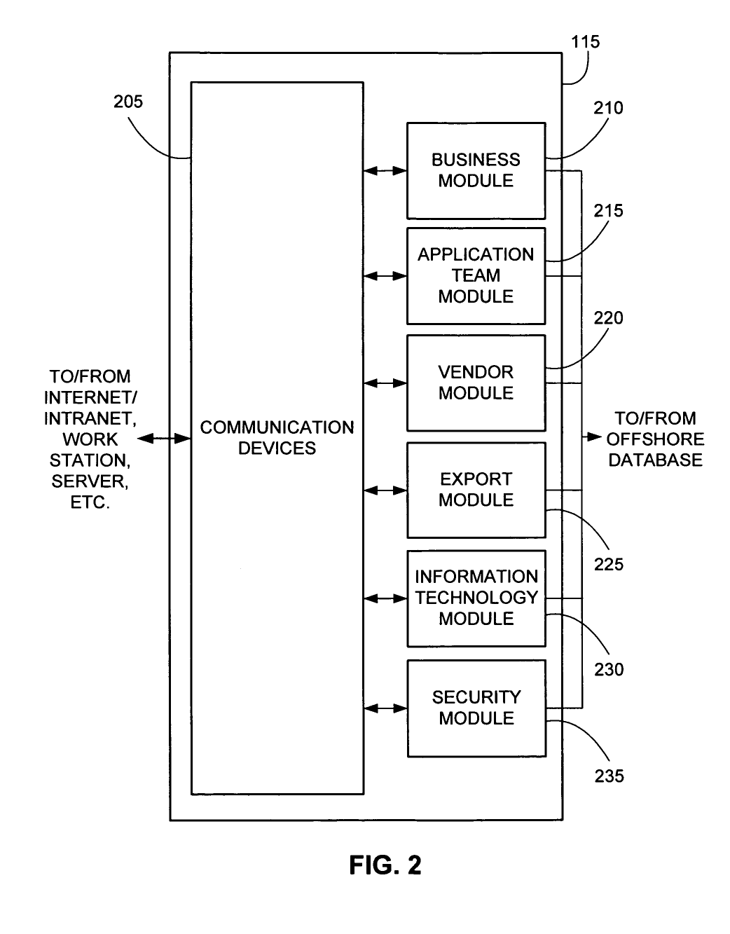

An example offshore module 115 is shown in FIG. 2. In the illustrated example, the user(s) may access various offshore module 115 sub-modules via the Internet/intranet, and/or workstation and one or more communication devices 205. The communication devices 205 may enable communication via web-pages and/or graphical and/or command-line user interfaces and/or kiosks. In the illustrated example of FIG. 2, the offshore module 115 includes a business module 210, an application team module 215, a vendor module 220, an export module 225, an information technology module 230, and a security module 235. Each of the aforementioned modules interacts with the communication device(s) 205 to provide an interface to receive and process inputs to set and/or modify communication and/or system resource configuration parameters which are stored in the offshore database 125.

Generally speaking, the offshore module 115 permits a user(s) to manage involvement with an offshore software development project. Various user(s) of the offshore software development system 100 have varying degrees of project responsibility and authorization. Therefore, many members of a project and/or sub-project have varying levels of access and/or capabilities to the offshore module 115. Members of the project may range from a highest level project architect (e.g., project manager, CEO, etc.), to a low level individual contributor (e.g. engineer, technician, project workers, etc.). For example, a business manager has a high level of responsibility as a project architect, thereby the business manager also has the highest authorization level when accessing the offshore module 115. The business manager also tracks all project initiatives that are outsourced to offshore development resources, reviews and resolves project issues, creates project status reports, establishes and manages statements of work (SOW), and disseminates key learnings and best practices.

The business manager(s) also set objectives/tasks for members of one or more application teams. For example, the business manager may create multiple application teams having any number of members based on project complexity. The application team is typically chartered with a responsibility to staff the project, sub-project, and/or task with resources meeting sufficient capabilities and skills. In contrast to the high level objectives established by the business manager(s), the application teams design a plan that accomplishes those project objectives. Included in the responsibilities of the application team (and their corresponding members) are determining necessary vendor resource skills, viewing/reviewing export controls and compliance therewith, viewing/reviewing system 100 connectivity and/or sub-system interconnectivity, and/or development of dashboards to communicate project status information and project metrics to business managers. As a result of these responsibilities, the application team may establish objective specific entities to meet project objectives.

As stated above, objective specific entities may include project managers and/or project management teams for vendors, export compliance requirements, information technology requirements, and/or security requirements. The vendor manager may include a workforce/team that researches appropriate vendors (e.g., project workers) that have the requisite talents and/or skills to meet project objectives. For example, if one of the project sub-tasks includes design, coding, and implementation of a web-based financial transaction system, the vendor manager may seek vendors with robust experience with C++ and JavaScript programming. Furthermore, the vendor manager may also seek such vendors whose particular software development skills have previously (and successfully) been applied in a high security financial environment.

Similarly, the application team may assign objective specific tasks to an information technology manager to establish and maintain connectivity requirements. The information technology manager is responsible for procuring appropriate computer and network hardware to allow users to interact with the offshore module 115 via the Internet 105, intranet 110, and/or workstation(s) 120. Furthermore, the information technology manager is responsible for staffing both domestic and international workforce resources to maintain and/or support user connectivity requirements. For example, the information technology manager may employ a call center of information technology engineers to field telephone calls of users that need assistance regarding connectivity and/or use of the offshore module 115.

The application team may also assign similar objective specific tasks to a security manager to ensure that the offshore module 115 is safe from unauthorized use and/or access. The security manager may employ resources to establish authentication protocols, verify password strength, establish preventative measures against virus threats and/or hackers, and/or maintain a current list of authorized users. For example, as new employees, vendors, and/or contractors are hired by the various managers, the security manager may add those individuals to the list of authorized users. Similarly, as employees, vendors, and/or contractors complete their objectives or are terminated, the security manager may remove such entities from the list of authorized users. Additionally, the security manager may be chartered with performing background checks on prospective employees, vendors, and/or contractors. In view of the aforementioned example web-based financial transaction system, the security manager may perform authorized research into prospective employee criminal history, and/or financial viability of the prospective vendors and/or contractors.

Returning to FIG. 2, each of the business module 210, the application team module 215, the vendor module 220, the export module 225, the information technology module 230, and the security module 235 provide authorized user(s) with interactive functionality specific to various business objectives. Such functionality may be provided to the user(s) via one or more dynamic web pages and/or an application executing in one of the modules that responds to authorized requests (e.g., a client/server application). Information accessed and/or entered by the various modules is retrieved and/or stored in the offshore database 125. Each of the various modules (210, 215, 220, 225, 230, 235) may be implemented on a workstation or server, or each individual module may be implemented as a server communicatively connected to the other modules. For example, the offshore module 115 may include a business server, an application team server, a vendor server, an export server, an information technology server, and a security server.

The business module 210 is typically used by the business manager. As discussed above, the business manager has the highest level of responsibility as the primary facilitator, motivator, and/or architect of a project. Access to the business module 210 (e.g., a manager server) provides the business manager with, among other things, high level project and/or sub-project status information. If various facets of the project and/or sub-project require high level authorization because, for example, expensive capital assets must be purchased to allow the project to succeed, then the business manager may review such authorization requests via the business module 210. Various graphical user interfaces (GUIs) are generated by the business module 210, such as performance dashboards, Gantt charts showing project timeline metrics, and/or authorization requests from employees, managers, and/or team leaders working for the business managers.

Large projects typically involve a greater number of administrative levels in a hierarchy. Each level of the hierarchy may involve a specific and focused set of objectives that, when working in concert with other hierarchical levels, results in an efficient project outcome. Smaller projects, on the other hand, may not require such detailed and/or segregated hierarchical levels. For example, an application team manager may function as the highest level leader of smaller projects, and take on responsibilities typically held by a business manager. Alternatively, the business manager may function as the highest level leader, yet execute some or all of the responsibilities typically performed by the application team manager (e.g., a “hands-on” business manager). In view of such diverse project types, the various modules of FIG. 2 may be employed and configured as needed.

As discussed above, the business managers may set objectives and/or tasks as a responsibility for one or more application managers. The application managers may employ the application team module 215 to assist in executing project objectives and tasks. A manager, whether high or low level, may be chartered with managerial responsibilities for many projects. Accordingly, the manager may employ the various offshore module 115 sub modules 210, 215, 220, 225, 230, 235 to determine whether such sub-modules require the manager's attention for any particular project and/or task. For example, a manager chartered with a task to secure IT professionals may view the task details on a task-by-task basis with a GUI. If the manager selects the task associated with securing the IT professionals, then the manager may be directed to the resources of the IT module 230 to determine project requirements, resources used in the past, and/or best practices that have been implemented previously with good results. In other words, a specific manager may have varying degrees of access to the other modules 210, 215, 220, 225, 230, 235 to aid in the communication and completion of projects and/or tasks in a more efficient manner.

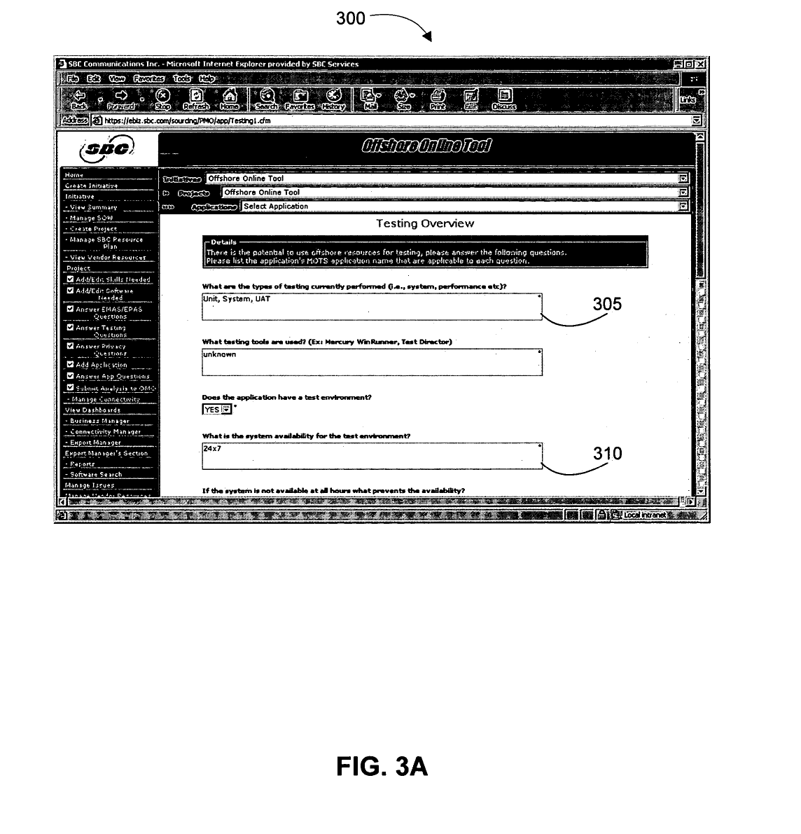

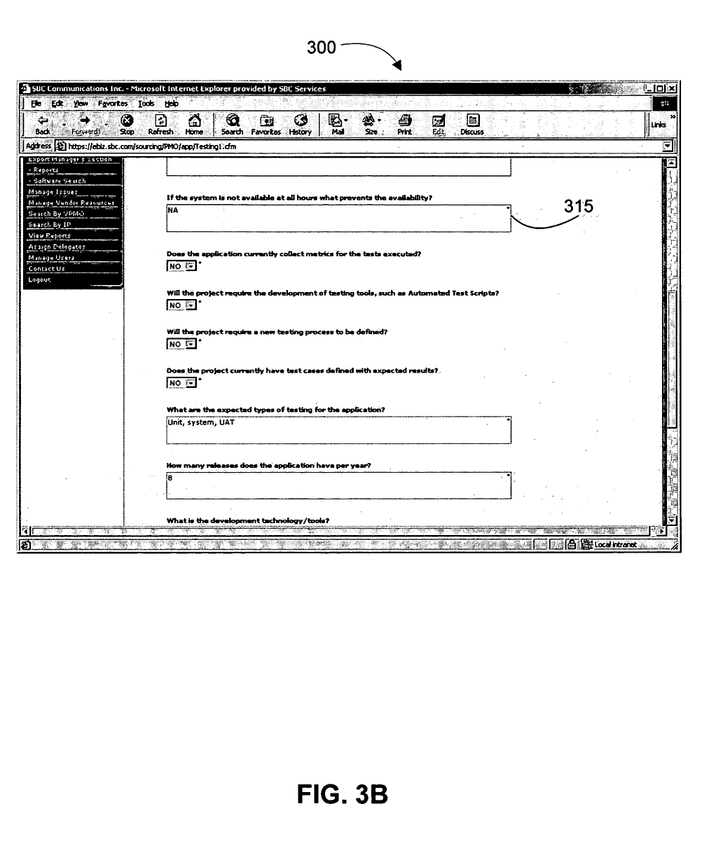

An example GUI 300 provided (e.g., a designed or an assembled web page) by the application team module 215 for communicating a project testing overview is shown in FIG. 3A. The GUI 300 may be implemented as a web page, or by any other format. One or more members of the application team may generate and/or populate fields within the GUI 300 for the benefit of status updates for the (higher level) business managers. Information appropriate for each of the fields may instruct other teams and managers to update their specialized information on a periodic basis (e.g., daily, weekly, etc.). For example, the application team may populate information related to test types in a test-type field 305, while the vendor manager may populate information in a test-availability field 310 related to system availability. The vendor manager is privy to the working hours and skills of the selected vendor(s), therefore the vendor manager is the most appropriate party to populate this test-availability field 310. However, as shown in FIG. 3B, an availability-explanation field 315 is provided to allow the vendor manager (or any other authorized and appropriate user) to place reasons why full-time testing is not available. Of particular importance in managing projects having some tasks in foreign countries is managing periods of unavailability due to dissimilar time zones. As such, if the vendor manager knows that foreign testing resources are not staffed twenty-four hours a day, seven days a week, the vendor manager may enter those reasons in the availability-explanation field 315.

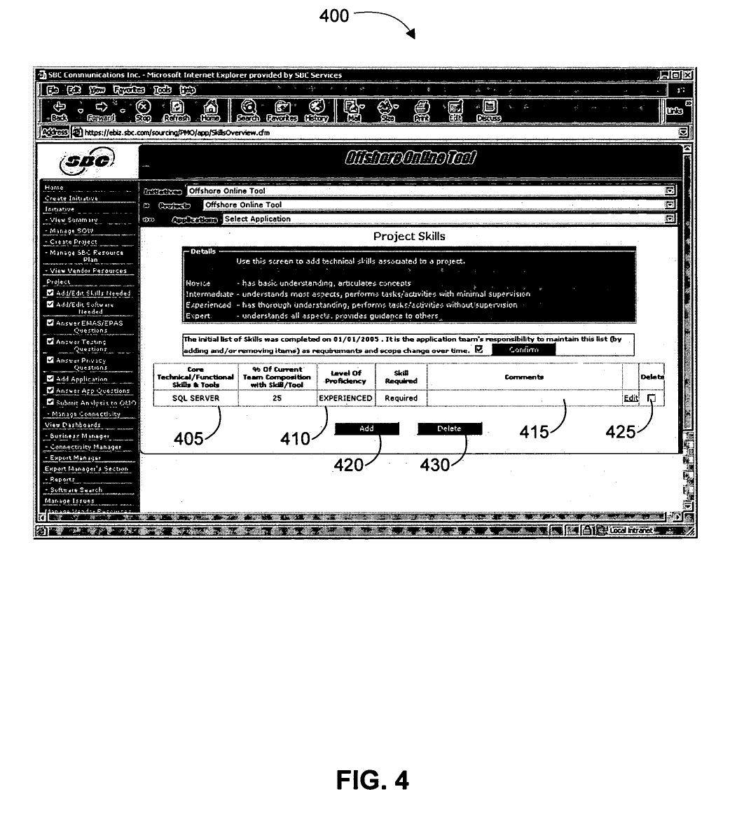

The application team module 215 may also facilitate a required project skills GUI 400, as shown in FIG. 4. The project skills GUI 400 is particularly useful for the vendor manager to learn which core technical and/or functional skills and tools are necessary to meet project objectives established by the business manager(s). As discussed above, while the business manager(s) may specify a high level objective/goal such as implementation of a web-based financial transaction system, the application manager will determine how to meet that objective. The example project skills GUI 400 illustrates one such required skill to accomplish the objectives in a skills field 405. Because the application team manager has determined, either alone or in cooperation with the vendor manager, that SQL server skills are necessary for the project, the vendor manager may search for qualified vendors and/or contractors. The application manager may further specify additional parameters of the requested skills, such as with a proficiency level field 410 and a comments field 415. As the application manager determines additional skills needed for the project, such skills may be added to the GUI 400 via an add button 420. Conversely, when such skills are no longer needed, or when such resources possessing those skills have been secured, and authorized user may select a delete check-box 425 and select a delete button 430.

As discussed above, the vendor manager may be chartered with the responsibility of procuring competent skills and resources to meet objectives and tasks developed by the business and/or application team managers. The vendor manager may employ the vendor module 220 to help meet such assigned objectives and tasks. As discussed above, each of the modules, including the vendor module 220, may be implemented as a server. Such servers are sometimes referred-to as project worker servers due to, in part, their role in allowing various sub-managers and/or individual contributors to access the offshore module 115 to receive offshore project instructions and provide project status updates. The vendor manager module 220 facilitates several functions, including the ability to store actual vendor resource information and relate such resources to various projects and/or sub-projects. Vendor resource information may include, but is not limited to vendor name, vendor employees, vendor location, and vendor historical data such as, for example, past projects with which the vendor has accomplished. The vendor module 220 may also facilitate various vendor tracking metrics such as, for example, delivery obligations, delivery dates, and service costs.

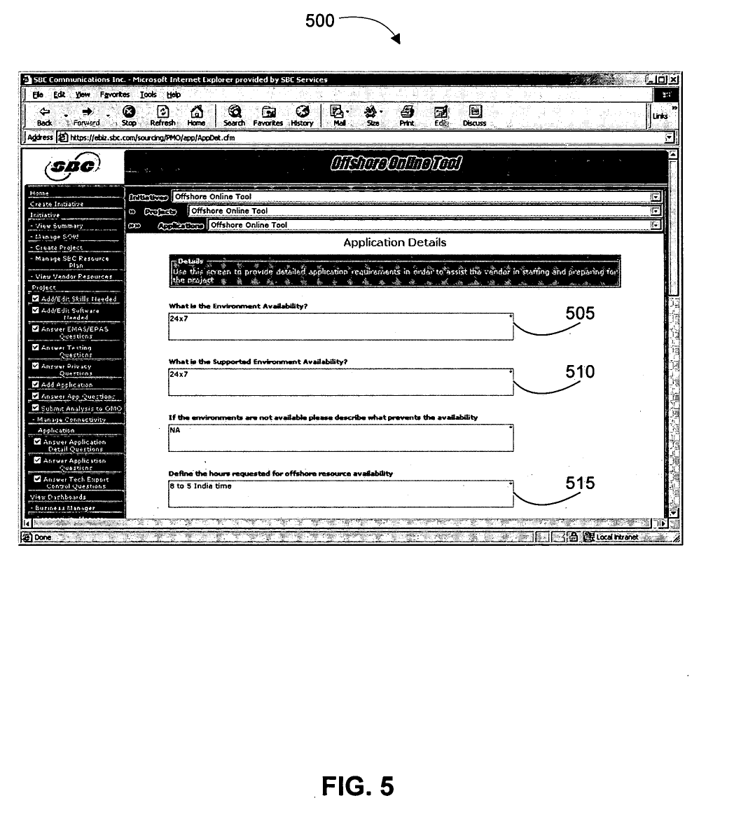

The vendor manager may be further guided by an application details GUI 500 as an aid to secure competent resources, as shown in FIG. 5. The application details GUI 500 provides the vendor manager with various fields to communicate staffing needs. For example, an availability field 505 indicates availability expectations to the vendor manager. Alternatively, the vendors may edit fields in response to posted expectation demands/requests. In particular, a vendor may enter supported environment availability information 510 and/or specific hours of offshore resource availability 515 in the country where the vendor is located.

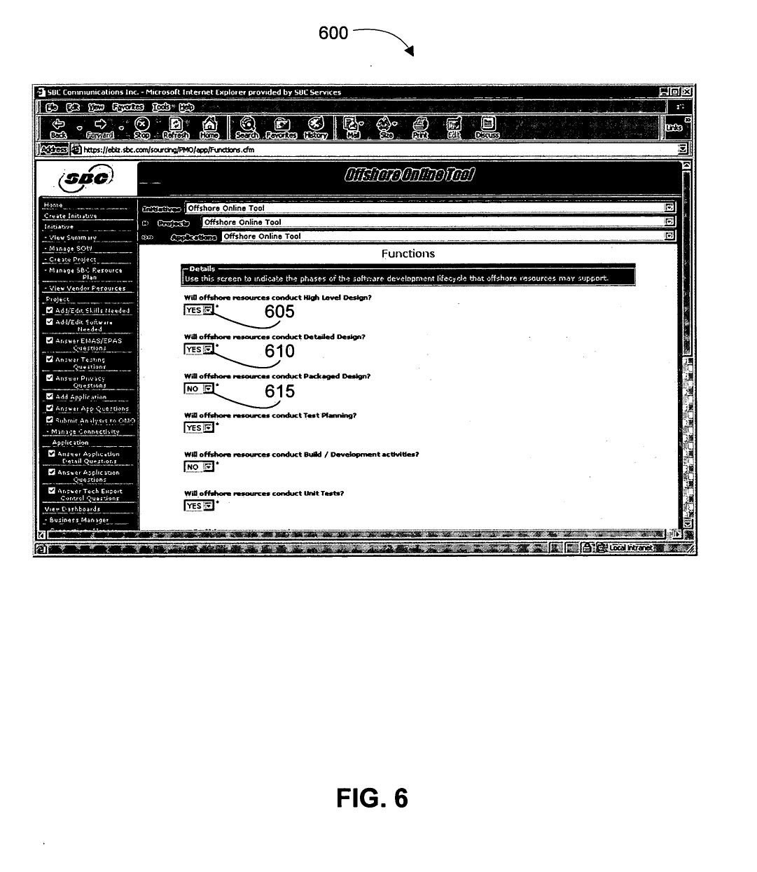

The vendors may receive additional information relating to functional responsibilities via a vendor function GUI 600, as shown in FIG. 6. The GUI 600 may present a series of yes/no drop down boxes to communicate particular vendor responsibilities during a software development lifecycle. For example, if the vendor is expected to conduct high level design, detailed design, and package design, then drop down boxes 605, 610, and 615, respectively, will indicate corresponding answers. The vendor function GUI 600 need not be limited to viewing by only the vendors, vendor managers, application mangers, and/or business mangers. For example, because the high level design drop-down box 605 indicates “Yes,” thereby requiring the vendor to perform high level design, the associated module (e.g., application team module, 215 vendor module 220, etc.) may notify the export module 225. The notification may remind the export manager to determine whether the foreign country in which the high level design is being performed has any of their own export laws. Such laws may require that special licenses be secured before the vendor's work product is legally delivered to parties in the United States. Proactive investigation into such laws and/or regulations, if any, minimizes or eliminates scheduling surprises and improves project efficiency.

In view of various offshore software development tasks and objectives, software will be exported both from the host country (e.g. the United States) to a foreign person or country, and vice-versa. In particular, the United States enforces various export laws and/or regulations, of which project managers must be aware to avoid violation. Generally speaking, an export is the transfer of anything to a foreign person and/or country by any means. For example, the Code of Federal Regulations (CFR), Title 15 concerns commerce and foreign trade. Parts 730 through 774 are further known as the Export Administration Regulations (EAR). More specifically, part 730 includes objectives of, in part, prohibiting violations of boycott restrictions levied against various countries. The export controls of EAR are also intended to serve national security and foreign policy interests of the United States. Such controls stem the proliferation of weapons, limit terrorism support capabilities, and protect the United States from adverse impacts related to unrestricted exports of commodities in short supply. In short, the reasons for United States export controls are diverse and cover concerns of national security, foreign policy, proliferation, materials in short supply, anti-terrorism, crime control, high performance computers, and UN sanctions.

The EAR provides guidance regarding appropriate questions that, when answered, illustrate potential compliance issues, if any. For example, export restrictions differ based upon the type of item considered for export, thus asking and identifying the item is one of many recommended questions. Items under consideration for export typically fall under one of ten categories, including materials, electronics, computers, telecommunications, and information security, to name a few. While the EAR provides guidance to self identification of items via various lists, in an abundance of caution, the United States Bureau of Export Administration will classify the item(s) and/or advise an exporter whether it falls under EAR. The EAR also suggests specific inquiries regarding where the item is going and who will receive the item(s). Furthermore, while the initial destination may be in an approved country, further queries should determine whether or not the item will be re-exported by a first foreign country to a second foreign country.

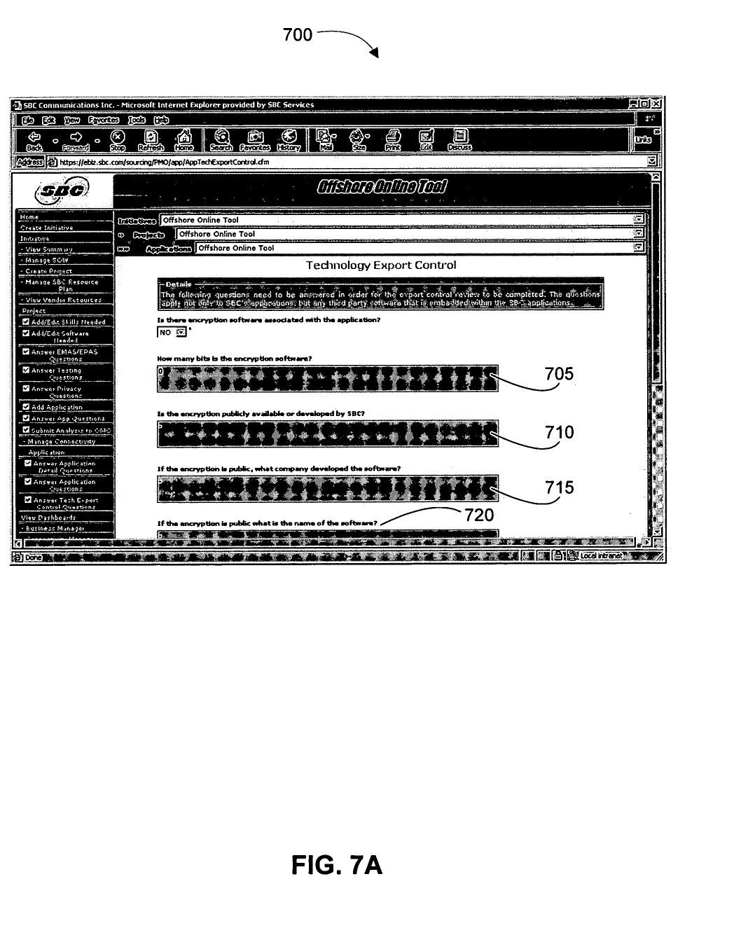

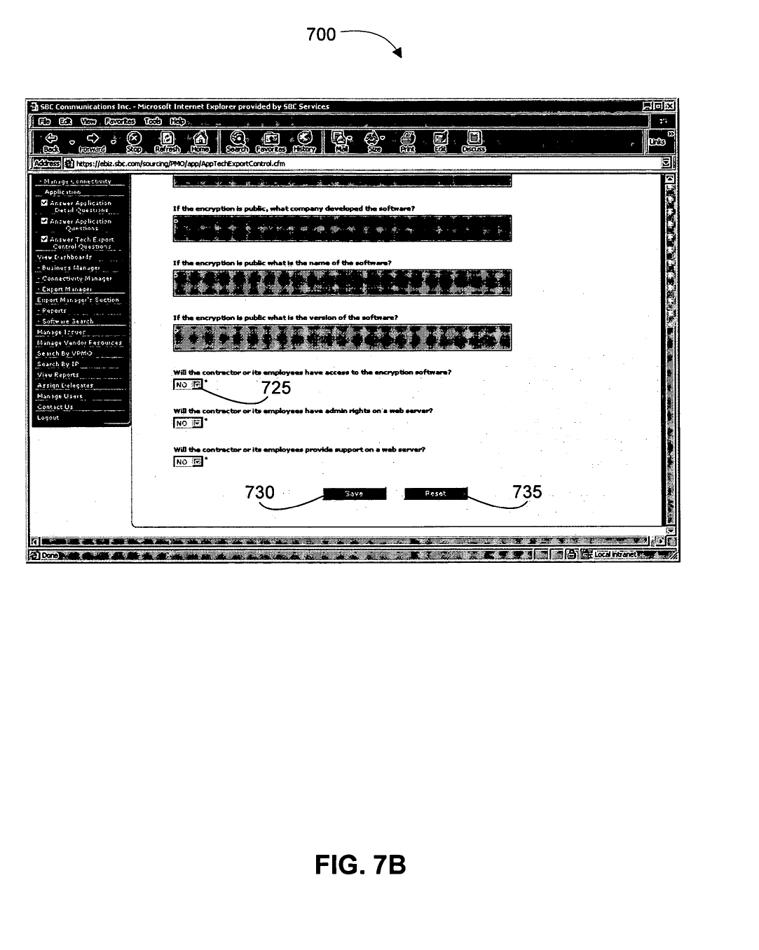

Of particular help to the export manager is an export module 225 to aid efforts to comply with various export laws and regulations. An example export control GUI 700, as shown in FIG. 7A. As discussed above, the export manager is chartered with the responsibility to ensure that project objectives comply with appropriate export laws. The export manager may design, assemble, and/or configure the export control GUI 700 to communicate important questions that permit successful international project management. The export module 225 may provide the export manager with a tool to design, assemble, and/or configure the GUI 700. For example, the export module 225 tool may provide a “clean slate” workspace, upon which the export manager may place specific questions pursuant to current and/or relevant export laws and/or regulations.

Additionally, the tool provides text response fields for which subsequent viewers (e.g., project workers, individual contributors, project managers, etc.) of the GUI may enter information and answers to the questions. For example, a subsequent viewer may answer preliminary and/or standard questions about the project, such as an answer that discloses which destination country in which the project will be developed. Depending on the current export laws, the export module 225 may automatically generate license application forms/papers, for example, in an effort to expedite export law compliance when dealing with that identified foreign country. Because the tool allows simple GUI creation, design, and modification, the export manager may quickly react to rapid project design and/or objective changes without relying upon specialized information technology talent to design GUIs and/or web pages. As new software projects and sub-projects are requested by business managers, the export manager may react in a timely fashion by creating a GUI for that project having relevant questions for various responsible parties.

For example, the GUI 700 of FIG. 7A includes an encryption strength query field 705. Because export laws may dictate particular restrictions for software and/or hardware based on encryption strength, such information permits the export manager to determine compliance issues with a project objective. Additional examples of potentially relevant question fields to aid the export manager in determining export law compliance include, but are not limited to, encryption availability to the public 710, identity of the company that developed the encryption software 715, and the name of the encryption software 720. Additional fields and questions of FIG. 7A are shown in FIG. 7B. Drop down boxes may also be included in the GUI 700 to allow the application manager, or any other user having a responsibility to communicate information, to provide answers and/or information to the export manager. A drop down box to communicate the extent of encryption software access 725 allows the user to select “Yes” or “No” answers. Upon completion of some or all fields of the GUI 700, the user (e.g., application manager, vendor manager, and/or team members thereof) may select a save button 730 to update the entered information to the offshore database 125. Selecting the save button 730 may also instruct the export module 225 to notify the export manager and/or employees working for the export manager. Alternatively, a user selecting a reset button 735 results in clearing all of the fields in the GUI 700 to a blank or default condition.

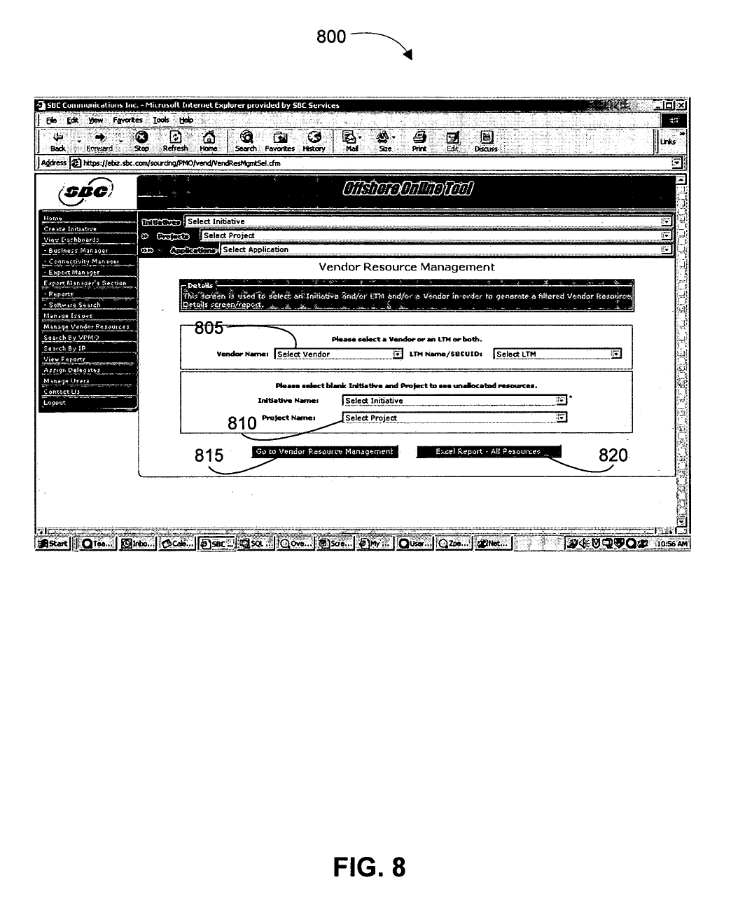

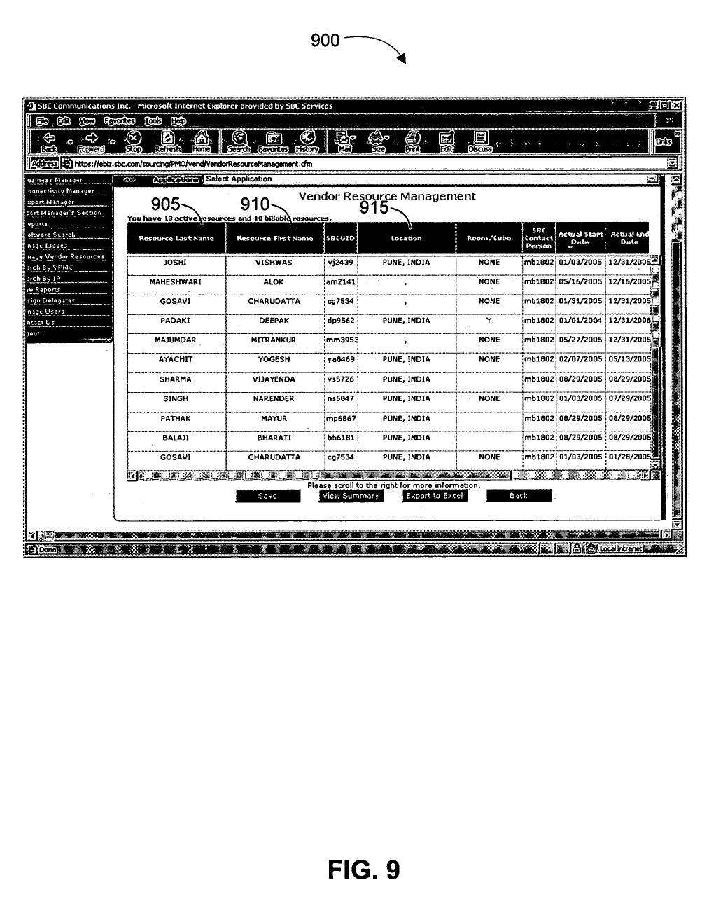

Export law compliance is not limited to regulation of specific technology and/or encryption bit strength for hardware and software, but may also include various foreign nation and individual party restrictions. Certain provisions of the EAR require an exporter to comply with a denied persons list of the Commerce Department. An example vendor resource management GUI 800 of FIG. 8 may be used by an export manager to compare vendor and/or employee names against the Commerce Department list of denied persons. The vendor manager may, via a separate GUI, a tool, and/or utility of the offshore module 115, enter vendor names and/or employee names to the offshore database 125. Other users, particularly the export manager, may select a vendor name from a vendor name drop down box 805 and/or a project name drop down box 810 of the GUI 800. While the drop down boxes of FIG. 8 may display any number of results to the user, persons of ordinary skill in the art will appreciate that the user may also type in specific characters and/or select a “show all” option. After the user selects a vendor resource management button 815, the user is presented with corresponding results, as shown by a results GUI 900 in FIG. 9. Additionally, or alternatively, the user (e.g., export manager) may select an Excel® report button 820 to have the output generated in a spreadsheet format for easier review and comparison. FIG. 9 includes a resource (e.g., employee) last name field 905, a resource first name field 910, and a location field 915, to name a few. Such vendor information allows the export manager convenient review capabilities to advance efforts of compliance with export laws.

Persons of ordinary skill in the art will appreciate that additional output fields may be added to the GUI 900, including, but not limited to, vendor company name, resource address and/or resource telephone number. Alternately, or in addition to an on-screen output of vendor resource information, the export module 225 includes an export engine adapted to download various export laws and/or other export related regulatory information from various sources. Sources may include publicly accessible web sites and/or web sites that require authentication credentials prior to access. Such web sites include those established and administered by various governmental entities adapted to communicate export related laws, regulations, and/or general information, such as information related to denied persons lists. For example, US Department of Commerce Bureau of Industry and Security (BIS) provides a denied persons list as a delimited text file. The text file includes various header fields, including, but not limited to, the name of the denied person, address, effective date, and/or an expiration date that the individual or business will no longer be restricted. The BIS also provides other information that enables businesses to maintain proper compliance with EAR, such as whether an Export Control Classification Number (ECCN) fits a particular product intended for export and/or re-export. Once an ECCN has been identified, an exporter can consult the Commerce Control List (CCL) and/or country list to determine if the product requires a license. Similarly, the US Department of Treasury Office of Foreign Assets Control (OFAC) enforces economic and trade sanctions based on US foreign policy and national security goals. As such, the OFAC also publishes delimited, fixed-width, and comma separated value text files containing blocked persons.

The export module 225 automatically accesses each of the various web sites, provides authentication credentials, if necessary, and adds and/or updates contents to the offshore database 125. Persons of ordinary skill in the art will appreciate that the offshore database 125 may be implemented via various database products including, but not limited to, Oracle® database management products and/or SQL database management products by Microsoft®. The database may be populated with data from delimited files, Extensible Markup Language (XML) files, and/or data parsed from the web page. Moreover, the export module 225 may be adapted to periodically cross-check the denied persons list (and/or any other national regulatory agency and/or government body), for example, against vendor data in the offshore database 125. Such automatic and periodic updating and cross-referencing procedures enable proactive and prompt handling of export law compliance issues. Upon the export module 125 finding a match between the denied persons list(s) and the vendor data, the export module 225 may notify the export manager via e-mail and/or any other telecommunications device/method.

Additionally, or alternatively, the export manager may manually invoke a query of any particular legal, regulatory, and/or administrative website. For example, the export manager may, via a GUI, initiate a process to automatically download delimited text files from one or more web sites, save the files to a memory (e.g., the database 125), compare the text file data to project data, and generate an output file with results. The results may include, but are not limited to, listed matches of prospective and/or current employees, contractors, and vendors. Such output results may be generated as a web page, an Adobe® PDF file, a Microsoft® Excel® spreadsheet, a text file, and/or a Microsoft® Word® document.

The information technology module 230 is typically chartered with various system 100 connectivity tasks to enable unfettered access to various system 100 users. As discussed above, the users may include employees, managers, contractors, and/or vendors that reside in various parts of the Earth. Persons of ordinary skill in the art will appreciate that such users access the system 100 via internet routers and firewalls. The information technology (IT) module 230 permits an IT manager and/or IT employee to access and configure routers and firewalls to allow internet traffic to/from users. Port management facilitation management is also provided by the IT module 230, which allows the user (e.g., the IT manager) to add, remove, edit, and track specific computer ports and software on individual systems of the system 100. As other offshore resources, such as new vendors, require connectivity to the system 100, the IT module 230 may identify and communicate best practices for IT hardware and software configuration. Implementation of such best practices improves set-up and maintenance efficiency for users and/or managers of various system 100 components.

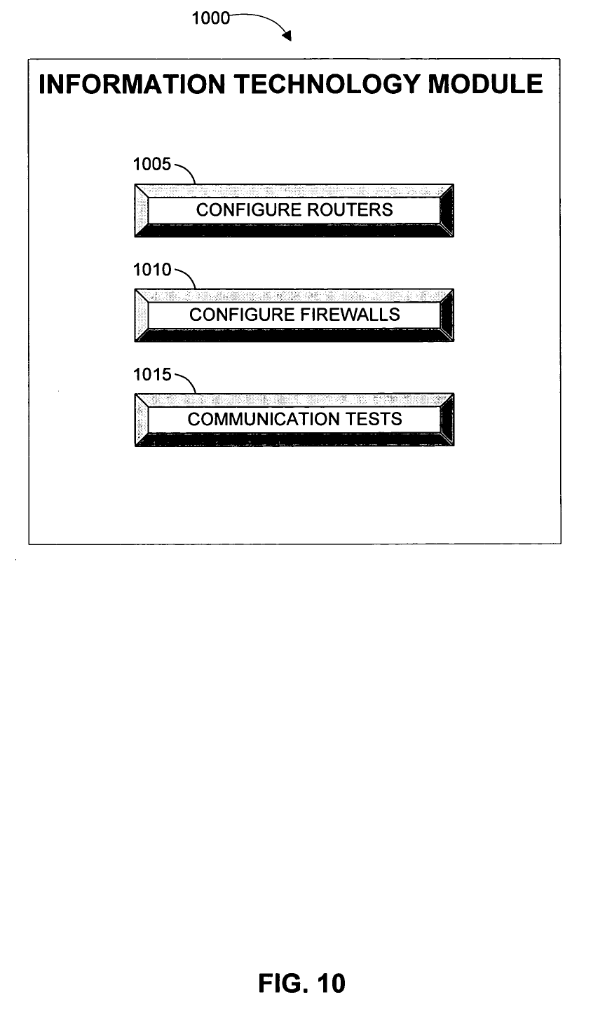

An IT module 230 GUI 1000 of FIG. 10 may, for example, provide the IT manager with router access control to configure the router(s) in a manner that will allow inbound access to the system from the users. Similarly, the IT manager may configure such router(s) in a manner that will allow outbound access from the system 100 to the users. Such router configuration is achieved by the user of the GUI 1000 clicking on a configure routers button 1005. Upon clicking on the configure routers button 1005, the user is presented with a list and/or pictorial representation of the routers associated with the system 100. The user may, then, select one or more of the routers to adjust configurable settings of the selected router. Moreover, the IT module 230 GUI 1000 permits the IT manager to update various firewall settings with a configure firewalls button 1010. Firewall settings are typically set in a default mode to block all inbound and outbound traffic. However, the firewall may be modified by the user, upon clicking on the configure firewalls button 1010, to permit access to/from various users on a list (e.g., a “white-list”) in a manner similar to that of the configure routers button 1005. The IT module 230 GUI further provides the IT manager with an ability to test and verify the communications between the system 100 and any users authorized to interact therewith. If the user selects a communication tests button 1015, then the user is provided with a list of test functions that may illustrate communicative success and/or failure between different nodes of a network. The communication tests may include, but are not limited to, a “ping” test, a “tracert” test, and an “ipconfig” query. Each of these example tests provides valuable data related to the operation and/or health of a network, as is understood by persons of ordinary skill in the art.

The security module 235 is typically chartered with various system 100 connectivity tasks related to security. The security module 235 may operate in cooperation with the IT module 230 to learn of various pieces of hardware that make-up the system 100. For example, the IT module 230 may contain a current list of all known nodes and/or hardware (e.g., workstations, servers, hubs, firewalls) that are connected to the system 100. Because vendors and various third parties interact with the system 100, such vendors and/or third parties are typically obligated to disclose what kind of hardware they are using to access the system. Alternatively, the business managers may dictate to the vendors and/or third parties an explicit list of approved hardware that may be used with the system 100.

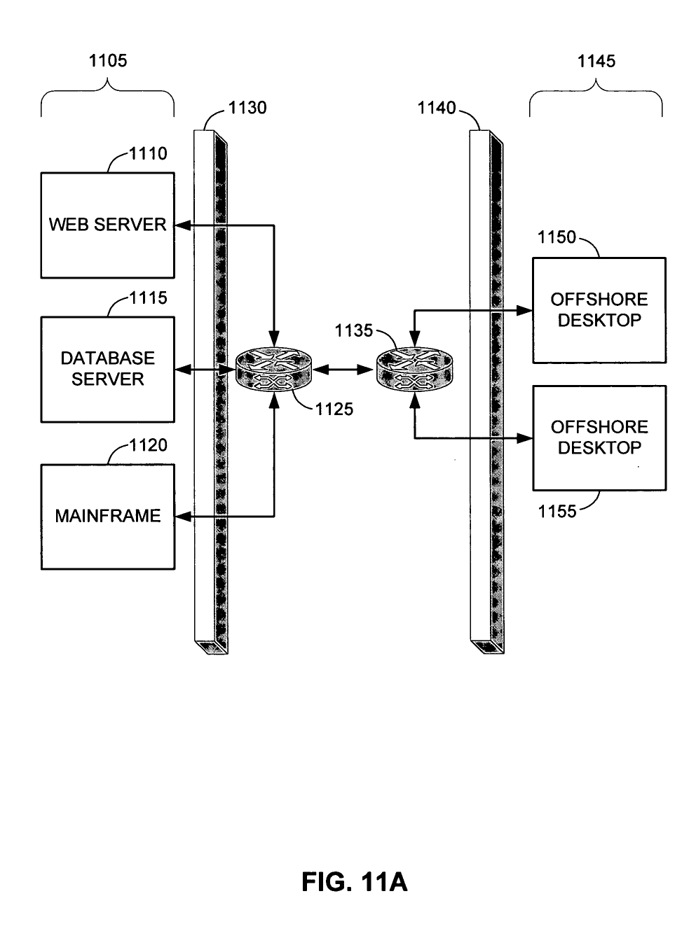

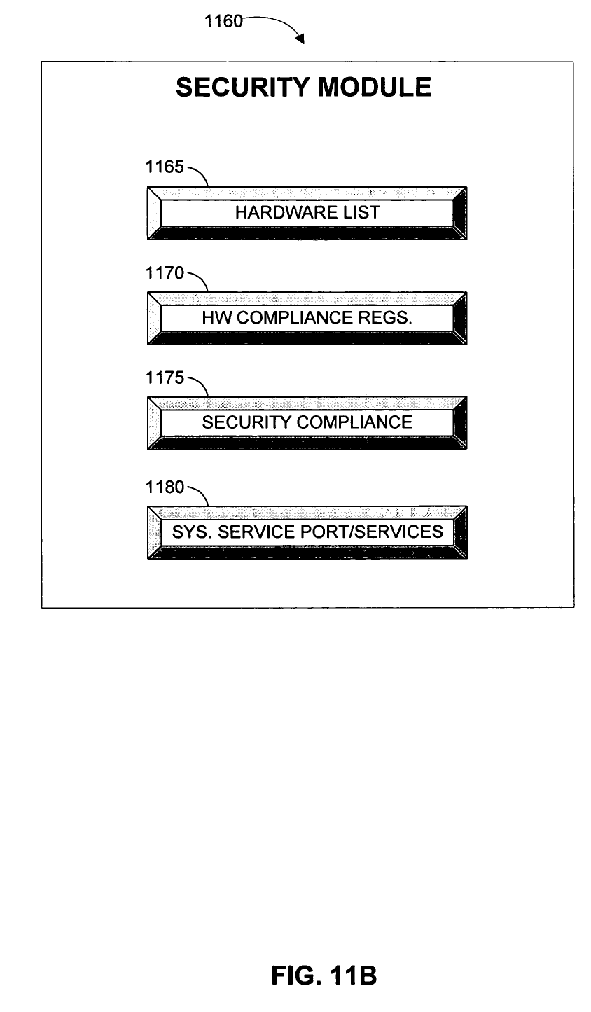

Without limitation, the hardware managed by the security module 235 may address various security aspects for system 100 hardware while including no direct control and/or management over hardware used by various third parties and/or vendors. In other words, the security module 235 may only be aware of various hardware owned and/or managed by administrators of the system 100. FIG. 11A illustrates an example environment 1100 in which the security module 235 may operate. The example environment 1100 includes example system hardware 1105, such as hardware owned and/or operated by the administrator of the system 100. The system hardware 1105 may include, but is not limited to a web server 1110, a database server 1115, and a mainframe 1120. The example system hardware 1105 may be communicatively connected to a router 1125 via a firewall 1130. The router 1125 and firewall 1130 are typically controlled and/or configured by the administrator of the system 100, whereas other router(s) 1135 and firewall(s) 1140 of a network, such as, for example, the Internet, may be controlled and/or configured by various third parties that choose to use the system 100. Third party equipment 1145 may include, but is not limited to, one or more offshore desktop devices 1150, 1155 (e.g., a computer, server, workstation, kiosk, etc.), and/or other network devices. For example, a third party, such as a contractor that chooses to use system hardware 1105 and/or various services of the system hardware 1105 may attempt communications to the web server 1110 via the Internet. The security module 235 is chartered with, in part, establishing security protocols of various communication paths to the system, including the router 1125, the firewall 1130, the web server 1110, and/or any other system hardware 1105 that may be communicatively coupled to any third party.

FIG. 11B illustrates an example GUI 1160 that allows a security manager to maintain and configure security procedures for the system 100. As discussed above, the security module 235 may cooperate with the IT module 230 to determine all of the hardware components that are an inherent part of the system 100 and/or are connected to the system 100 (e.g., by vendors and/or third parties) and share such information with the security module 235. In particular, if the security manager selects a hardware list button 1165, then the security manager is presented with the list of hardware devices (e.g., computers, servers, kiosks, hubs, switches, routers, firewalls, etc.) that operate with the system 100. Upon reviewing such a list, the security manger may select one of the hardware components to determine whether it has met appropriate security compliance standards. The security manager may then invoke a hardware scan on the selected hardware component to expose vulnerabilities, if any. For example, the hardware scan may expose needed firmware updates, OS patches, and/or missing anti-virus updates. Because the security manager(s) typically has system administrator privileges, the security manager may perform additional manual procedures on the hardware, as needed.

A security compliance flag may subsequently be set for each piece of hardware connected to the system 100 to indicate compliance status. Flags may include, but are not limited to, a color code and/or words to indicate status, such as the color green for “compliant/secure,” the color yellow for “marginal,” and red for “non-compliant/insecure.” The security module 235 may disable any and all hardware that has either not been scanned, or has been scanned, but resulted in a non-compliant status.

The security manager may update required security compliance procedures by selecting a hardware (HW) compliance regulations button 1170 from the example GUI 1160 of FIG. 11B. As discussed above, the security manager and/or other members of a security team are chartered with the responsibility of establishing and enforcing security protocols for the system 100. Authorized users, vendors, third parties, and/or individual contributors that choose to use the system 100 must comply with such procedures as designed by the security manger. As described above, the security module 235 may only provide the security manager with administrative access to hardware that belongs to the system 100, rather than such hardware used by third parties and/or vendors that connect with the system 100. On the other hand, persons of ordinary skill in the art will appreciate that various third parties and/or vendors may provide system administrator privileges to the security manager. As such, the security manager may employ the security module 235 to incorporate the hardware of third parties and/or vendors when performing security procedures. The procedures may include, but are not limited to, a list of approved hardware that may connect to the system 100, a list of approved programs that may operate on/with the system 100, recommended password configurations, and best practices for user ID's. The security information entered by the security manager may be in the form of general guidelines accessible by all the users and modules (e.g., the business module 210, application team module 215, vendor module 220, export module 225, and IT module 230). For example, if a particular user only interacts with the system 100 via the vendor module 220, then such vendor module 220 GUI may provide a link to the guidelines and/or compliance lists established by the security manager.

The security manager may also design and distribute a security compliance checklist for the various users of the system 100. If the security manager selects a security compliance button 1175 from the GUI 1160 of FIG. 11B, then the security manager may compile a checklist of tasks for the user to perform and/or confirm. For example, while the security manager has system administrative access for all of the system 100 hardware, some security procedures do not conveniently lend themselves to automatic scanning for compliance verification. The security compliance checklist may require that the users confirm a regular practice of deactivation of old user names, such as those user names associated with employees that have quit, were fired, or merely completed their obligations. Additionally, the security compliance checklist may require that hardware logging services be active. Hardware logging services are particularly useful for audit procedures to determine when particular system 100 hardware was used, and for what purpose. Each user may receive such a checklist via e-mail, or access the checklist after logging into the system 100 and submitting answers via a dynamic web page, for example.

The security manager may also investigate and/or control system 100 communication services. As discussed above, the IT module 230 provides the security module 235 with a list of all hardware connected to the system 100. If the security manager selects a system service port/services button 1180 on the GUI 1160 of FIG. 11B, then the security manager may review the list of system 100 hardware. Upon selecting any hardware component in the list, the security manager may review and/or control which communication ports are in use. For example, port numbers are typically divided into three ranges: well known ports, registered ports, and dynamic and/or private ports. The well known ports are those from 0 through 1023, the registered ports are those from 1024 through 49151, and the dynamic and/or private ports are those from 49152 through 65535. An example of a well known port is port 80, which is used for hyper text transfer protocol (http), such as the protocol typically used for transferring web pages. Another well known port is port 443, which is typically used for secure http (referred to as “https” or “http over secured sockets layer”). The security manager may restrict and/or allow various ports to be used on the system 100 hardware to align with particular security objectives. For example, the security manager may require that only high-security ports be used, such as port 443 and disable port 80 (or any other ports) on the hardware. Additionally, selecting the system service port/services button 1180 may also allow the security manager to learn which ports are active, inactive, or used in the past. For example, the security manager may access a log of the system 100 hardware (e.g., a server in an offshore location) to determine that port 10132 has been used frequently. Such port use information allows the security manager to take corrective action, if any. Additionally, or alternatively, the security module 235 may automatically scan all the system 100 hardware on a periodic basis for, among other things, authorized port settings and traffic. If unauthorized port traffic is detected on any particular system 100 hardware, the security module 235 may alert the security manager via e-mail, voice mail, and/or an alert message on a dynamic web page and/or GUI.

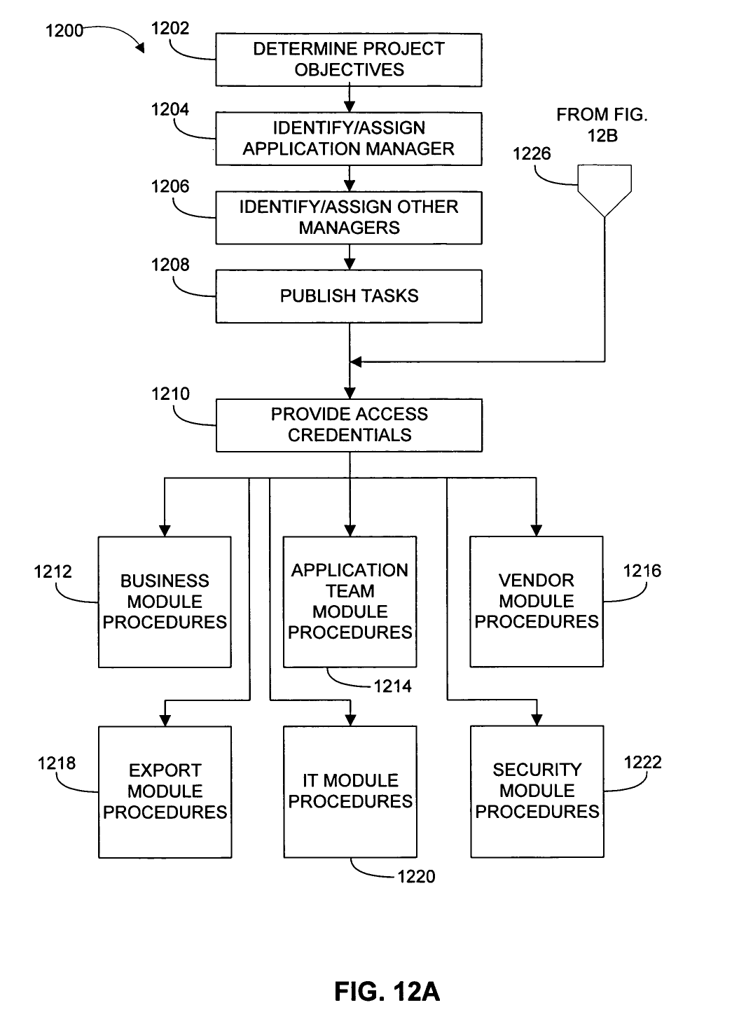

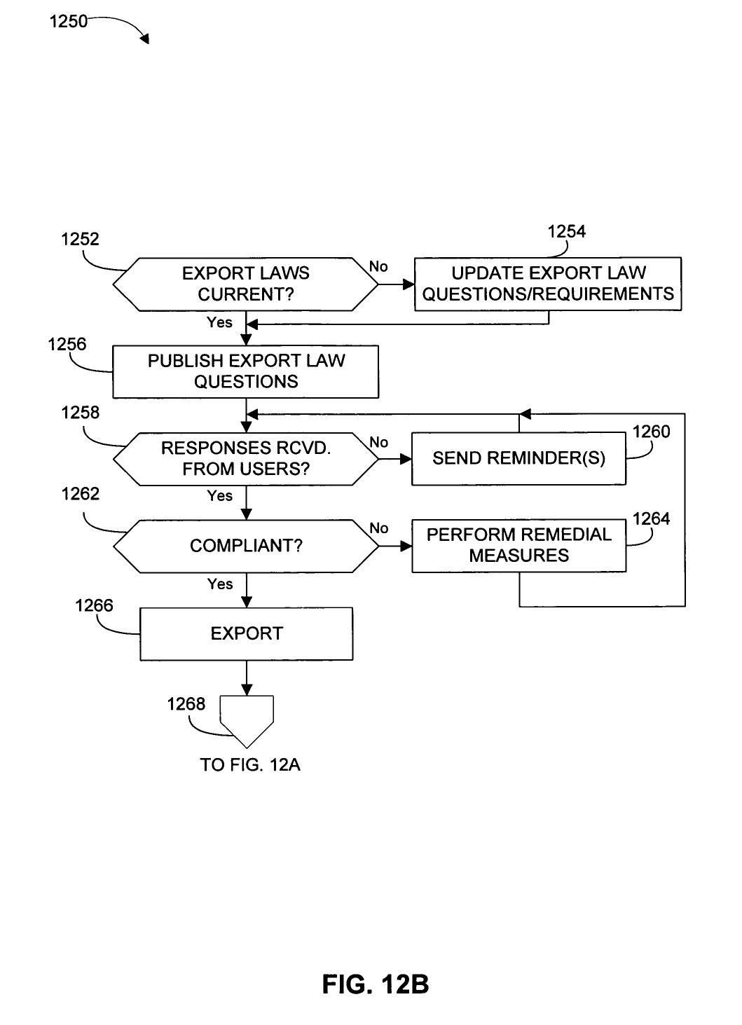

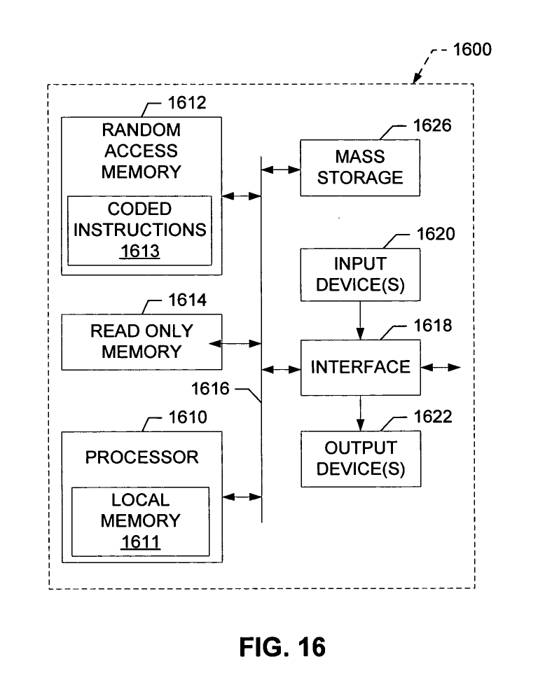

Flowcharts representative of example machine readable instructions for implementing the example system to manage offshore software development 100 of FIGS. 1 and 2 are shown in FIGS. 12A, 12B, and 13-15. In this example, the machine readable instructions comprise a program for execution by: (a) a processor such as the processor 1610 shown in the example computer 1600 discussed below in connection with FIG. 16, (b) a controller, and/or (c) any other suitable processing device. The program may be embodied in software stored on a tangible medium such as, for example, a flash memory, a CD-ROM, a floppy disk, a hard-drive, a digital versatile disk (DVD), or a memory associated with the processor 1610, but persons of ordinary skill in the art will readily appreciate that the entire program and/or parts thereof could alternatively be executed by a device other than the processor 1610 and/or embodied in firmware or dedicated hardware in a well-known manner (e.g., it may be implemented by an application specific integrated circuit (ASIC), a programmable logic device (PLD), a field programmable logic device (FPLD), discrete logic, etc.). For example, any or all of the offshore module 115, the offshore database 125, the communication devices 205, the business module 210, the application team module 215, the vendor module 220, the export module 225, the information technology module 230, the security module 235, and/or the graphical user interfaces of FIGS. 3-11 could be implemented by software, hardware, and/or firmware. Also, some or all of the machine readable instructions represented by the flowcharts of FIGS. 12A, 12B, and 13-15 may be implemented manually. Further, although the example program is described with reference to the flow chart illustrated in FIGS. 12A, 12B, and 13-15 persons of ordinary skill in the art will readily appreciate that many other methods of implementing the example machine readable instructions may alternatively be used. For example, the order of execution of the blocks may be changed, and/or some of the blocks described may be changed, substituted, eliminated, or combined.

A process 1200 of FIG. 12A begins at block 1202 where the offshore module 115 permits a user to enter project objectives. Such project objective information is received and stored in the offshore database 125 for later retrieval by other users of the offshore module 115. For example, a business manager and/or an application manager may determine high level project objectives, goals, costs, and/or scope. In view of the objectives, goals, costs, and/or scope, other users with appropriate skills and responsibilities may design lower level tasks that accomplish such higher level objectives. An application manager is identified at block 1204 that possesses the requisite skills to facilitate the identified project objectives. The application and/or business manager further identifies other managers, employees, and/or teams having corresponding skills and experience. Generally speaking, the users of the offshore module 115 include a workforce of resources that start with a high level objective and logically specialize with additional resources capable of accomplishing such objectives. In particular, the application manager identified at block 1204 further identifies (block 1206) specialized managers, team leaders, and/or teams including, but not limited to, a vendor manager, an export manager, an information technology manager, and a security manager.

The various specialized managers and/or team leaders publish various tasks previously designed to meet overall project objectives at block 1208. As discussed above in view of the export manager, each of the specialized managers may employ a manager module of the offshore module 115 to create/design various GUIs for a purpose of publishing task information to responsible resources (e.g., team leaders, employees, vendors, contractors, etc.). For example, as discussed above, the offshore module 115 may include a business module 210, an application team module 215, a vendor module 220, an export module 225, an information technology module 230, and a security module 235. Each of the managers and/or team leaders may employ the corresponding modules, which may contain various utilities and tools for GUI design and/or editing.

Team members, employees, contractors, and other users are provided with authentication credentials at block 1210. For example, the security manager may employ the security module 235 of the offshore module 115 to configure user identification credentials and passwords. The security module 235 may include GUIs, tools, and other utilities well known by persons of ordinary skill in the art that allow the security manager to configure usernames and passwords for users. After users are provided with access credentials, the offshore module 115 is generally in a state that allows the users, including managers, their team members, employees, vendors, and/or contractors to work on and/or manage project responsibilities. As such, process control directs to one or more alternate procedures as needed by the users, such as business module procedures at block 1212, application team procedures at block 1214, vendor module procedures at block 1216, export module procedures at block 1218, information technology procedures at block 1220, and/or security procedures at block 1222.

Persons of ordinary skill in the art will appreciate that additional and/or alternate modules or procedures may be employed depending on the project type. For example, a project involving project management with resources located in other countries, the export procedures 1218 may be particularly useful to help ensure compliance with export laws. An example export procedure 1250 is shown in FIG. 12B and begins at block 1252 in which the export module 225 determines if the export laws are current. The export manager may receive export law updates from an organizational standards body and/or government agency. Furthermore, the export manager may access a corresponding web page of the government agency to review and/or download the most recent export laws, when appropriate. Alternately, the export module 225 may automatically query the government agency web site and check date/time data associated with the export laws to determine whether such laws are newer or older than any previous versions saved in the offshore database 125. If the export module 225 determines that a more current version of the export laws are available, control proceeds from block 1252 to block 1254 and the most recent export laws are updated, as will be discussed in further detail below. Export law updates may be queried at a request of the export manager and/or automatically on a periodic basis. Such updates may further be saved to the offshore database 125.

Export law questions relevant to the project are published by the export module 225 at block 1256. As discussed above in view of FIGS. 7A and 7B, the export laws may be presented to various users in the form of questions, which may be easier for the users to understand, and such questions may be drafted to obtain specific data from the users that further enable compliance issues to be determined. The export module 225 determines whether the users have answered published questions at block 1258. If not, the example export procedure 1250 is directed to block 1260, in which one or more reminders are sent to the responsible user(s). Reminders may include an alternate GUI presented to the user(s) upon log-in to the offshore module 115, dialog boxes presented upon user(s) log-in to the offshore module 115, and/or e-mail message(s) to the responsible user(s).

However, if the responsible users have provided answers, as requested, control advances to block 1262 in which the export module 225 determines whether compliance issues exist. For example, if the user provides an answer of “1028 bits” for the encryption strength query field 705 of the example GUI 700 of FIG. 7A, the export module 225 may be adapted to compare that answer against a threshold value saved in the offshore database 125. The threshold value is typically determined pursuant to the current export laws, however business decisions by the business and/or application managers may also dictate this, and other threshold values. For example, if the export laws are such that exported software having encryption algorithms in excess of 64 bits requires a specific license, then the example answer of 1028 bits will cause the export module 225 to take remedial corrective measures at block 1264.

Such remedial measures may include e-mail notification messages to the export manager and/or the user(s) that provided the answer(s). Additionally, or alternatively, the remedial corrective measures may include alternate GUIs that communicate responsive tasks to abate non-compliance issues, and/or request additional information that, if provided, allow the specific license to be applied-for and obtained. If the export module 225 determines that the provided answers result in export law compliance, control advances from block 1262 to block 1266. Projects, sub-projects, and/or tasks that are compared against export law requirements prevent time consuming surprises during project management and increase the efficiency of project execution. Because projects and the various resources assigned to meet project objectives are not static and may change as the project proceeds, the process may proceed from block 1268 of FIG. 12B to block 1226 of FIG. 12A. For example, if project scope, project requirements, employees, and/or export laws change, then the processes of FIGS. 12A and 12B may repeat execution of various blocks as needed to ensure that project tasks comply with export laws.

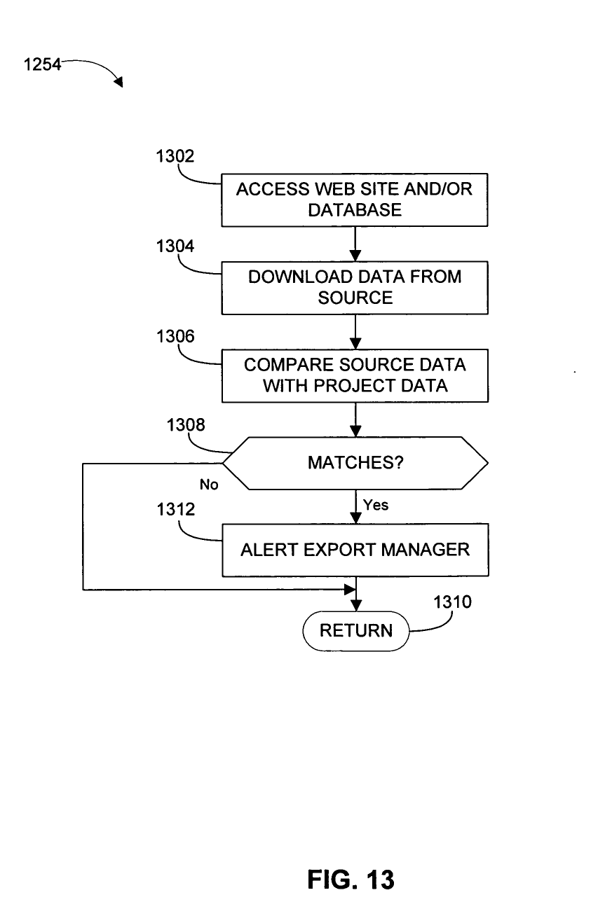

Returning to FIG. 12B, an example program to update export law questions and requirements (block 1254) is shown in further detail in FIG. 13. A process 1254 of FIG. 13 begins at block 1302 where the offshore module 115 accesses a website and/or a database containing regulatory and/or export law data. The export law data may include a text file (e.g., tab-delimited, comma-delimited, space-delimited, etc.), a web page, an XML file, a Microsoft® Excel® file, and/or a Microsoft® Word® file downloaded to the export module 115 (block 1304). If the export law data is in the form of a text file, the export module 115 may save the text file to the offshore database 125 and/or a separate memory location. If the export law data is in the form of a web page, XML file, Excel® file, and/or a Word® file, then the export module 115 may parse the file to extract relevant export law data to the offshore database 125.

When the export law data is received and/or stored in a memory location (e.g., the offshore database 125), the export module 115 invokes a database query to compare the export law data with offshore project data (block 1306). As discussed above, the export law data may include regulations, compliance parameters, and/or lists of people and/or businesses for which restrictions apply. If a match is not found between the export law data and the offshore project data, the program exits (block 1310). On the other hand, if a match is found between the export law data and the offshore project data, the export manager is notified at block 1312. As discussed above, notification may include, but is not limited to, an e-mail message, and a voice mail message.

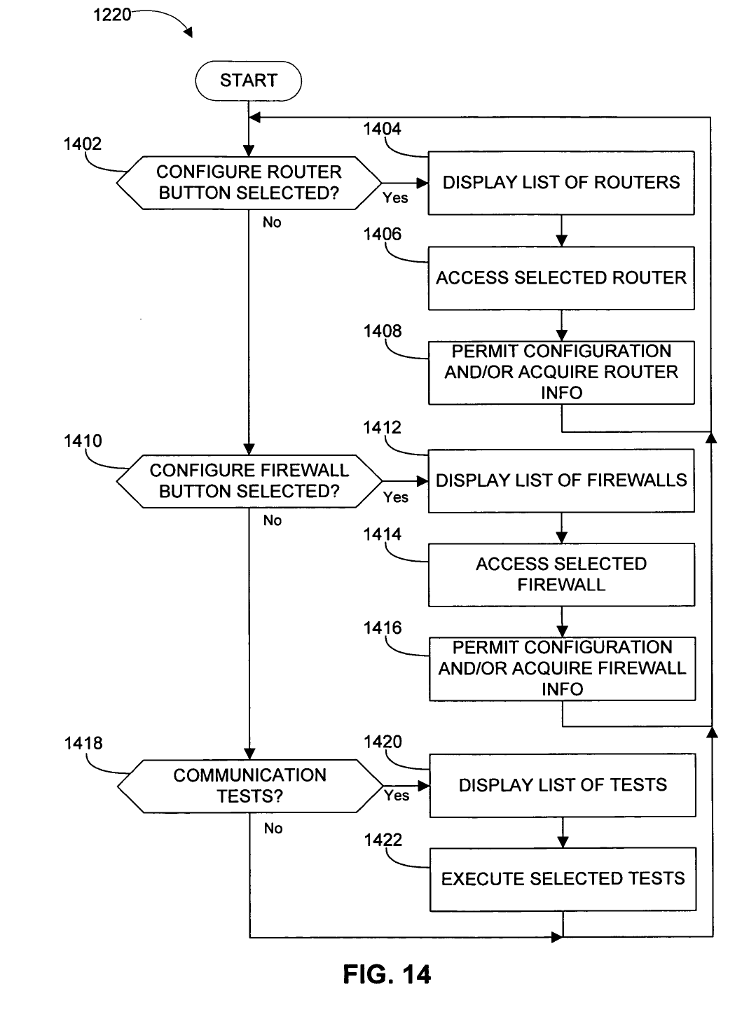

An example process of the IT module 230, which may execute the GUI 1000 of FIG. 10, is shown in FIG. 14. The process begins at block 1402 where the IT module 230 monitors for selection of the configure routers button 1005 of FIG. 10. Upon selection, the process advances to block 1404 where the IT manager is presented with a list of routers that the system 100 may use for communications. The IT manager may select a router at block 1406 and attempt to gain access to the router. Because each router typically has an internet protocol (IP) address, a corresponding password will allow router settings to be learned and/or modified.

Routers are typically “intelligent” devices that connect local area networks (LANs) and wide area networks (WANs). Routers may be protocol sensitive and support network interface functionality between similar and dissimilar networks. The traffic sent by routers may be based on routing considerations that include, but are not limited to, destination addresses, packet priority levels, minimum route delays, route congestion levels, and route distances. The routers may also confine data traffic within a specific subnet based on authorizations and/or privileges. Such authorizations and/or privileges may be set by the IT manager upon authorized access to any particular router. While the IT manager will typically not have access and/or control over all routers that span between various pieces of system 100 hardware, the IT manager will have control over such routers that are managed and/or owned by vendors and/or third parties. Changes to router configuration, after successful access at block 1406, occur at block 1408.

If the configure router button 1005 is not selected at block 1402, then process control advances to block 1410, which determines whether the configure firewalls button 1010 is selected. A firewall limits the exposure of a computer or group of computers to an attack. A firewall is typically employed on a LAN to deter and/or eliminate unauthorized persons from accessing the LAN to acquire and/or deposit information thereon. The firewalls may include, but are not limited to, packet filters, circuit gateways, application gateways, and trusted gateways. Typically, the firewall serves as a single point of entry where defenses can be implemented by an IT manager. The IT manager may implement various security policies with the firewall, such as rules allowing and/or prohibiting packets based on a source/destination address of a port number. If the configure firewalls button 1010 is selected, the process advances to block 1412 to display a list of firewalls, much like the process described above for block 1404. Similarly, much like block 1406, the process at block 1414 permits the IT manager (or other authorized user) to access a selected firewall and, at block 1416, make any adjustments to the firewall.

If the configure firewalls button 1010 is not selected at block 1410, then process control advances to block 1418, which determines whether the communication tests button 1015 has been selected. If the communication tests button 1015 has been selected, the process advances to block 1420 in which a list of available tests are presented to the IT manager. Persons of ordinary skill in the art will appreciate that tests may include, but are not limited to, simulated attacks on firewalls to test protection integrity, ping tests, and router instruction tests (block 1422).

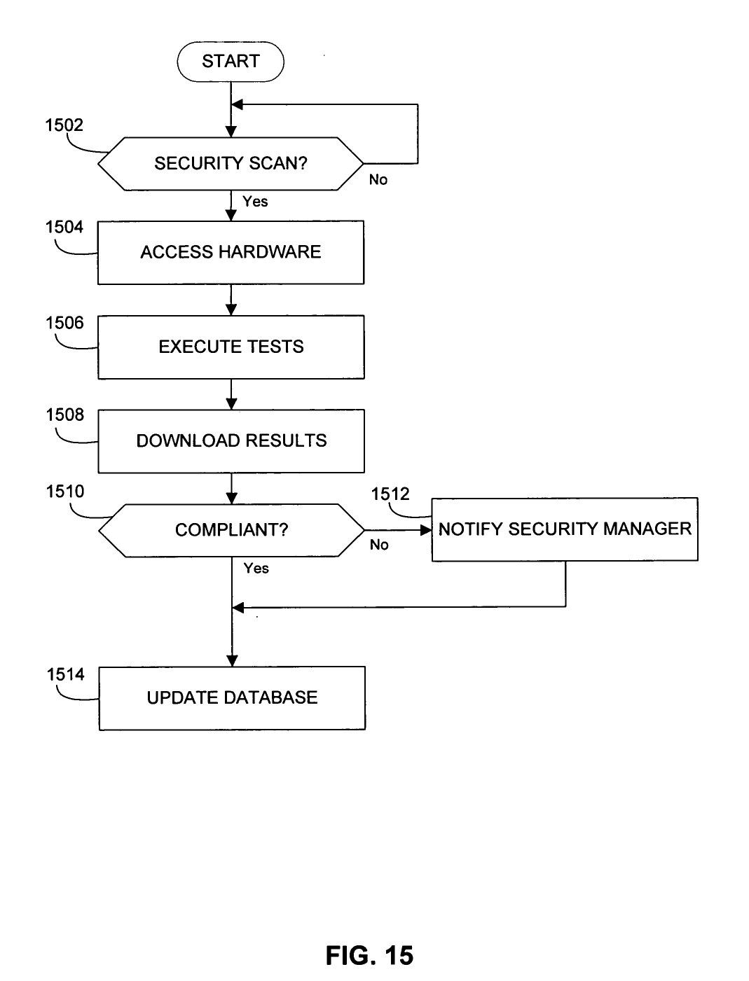

An example process of the security module 235 is shown in FIG. 15. The process begins at block 1502 where the security module 235 invokes a hardware security scan on a periodic basis (e.g., once per day) or in response to a request from the security manager. At block 1504, the security module 235 accesses a particular hardware component, such as a server, computer, and/or a kiosk. If the security scan process of FIG. 15 operates on a periodic basis, such scanning procedures may step through a list of hardware and perform vulnerability tests and/or security compliance tests in sequence or in parallel. Access to a particular hardware component may be driven by an automated script in which authentication credentials (e.g., a username and a password) are provided to the hardware under test. Process control advances to block 1506 where the tests and/or security compliance checks are executed. For example, one or more automated scripts may execute command line entries to gather information about the hardware, such as a “ver” command that returns operating system version information. Persons of ordinary skill in the art will appreciate that numerous command line entries may be executed to gather other hardware, software, networking, and/or system related information for any particular piece of hardware.

Information returned from the command line script execution is downloaded at block 1508 to a system 100 memory, such as the offshore database 125. The security module 235 compares the downloaded information against security policies and/or procedures at block 1510. If the comparison results in compliance and/or security vulnerabilities, process control advances to block 1512 where the security manager is notified (e.g., e-mail message, pager, etc.). Results of the security scan are then stored in the offshore database 125 for review by the security manager and/or any authorized user of the system 100.

FIG. 16 is a block diagram of an example computer 1600 capable of implementing the apparatus and methods disclosed herein. The computer 1600 can be, for example, a server, a personal computer, a laptop, a PDA, or any other type of computing device.

The system 1600 of the instant example includes a processor 1610 such as a general purpose programmable processor. The processor 1610 includes a local memory 1611, and executes coded instructions 1613 present in the local memory 1611 and/or in another memory device. The processor 1610 may execute, among other things, the example machine readable instructions illustrated in FIGS. 12A, 12B and 13-15. The processor 1610 may be any type of processing unit, such as a microprocessor from the Intel® Centrino® family of microprocessors, the Intel® Pentium® family of microprocessors, the Intel® Itanium® family of microprocessors, and/or the Intel XScale® family of processors. Of course, other processors from other families are also appropriate.

The processor 1610 is in communication with a main memory including a volatile memory 1612 and a non-volatile memory 1614 via a bus 1616. The volatile memory 1612 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 1614 may be implemented by flash memory and/or any other desired type of memory device. Access to the main memory 1612, 1614 is typically controlled by a memory controller (not shown) in a conventional manner.

The computer 1600 also includes a conventional interface circuit 1618. The interface circuit 1618 may be implemented by any type of well known interface standard, such as an Ethernet interface, a universal serial bus (USB), and/or a third generation input/output (3GIO) interface.

One or more input devices 1620 are connected to the interface circuit 1618. The input device(s) 1620 permit a user to enter data and commands into the processor 1610. The input device(s) can be implemented by, for example, a keyboard, a mouse, a touchscreen, a track-pad, a trackball, isopoint and/or a voice recognition system.

One or more output devices 1622 are also connected to the interface circuit 1618. The output devices 1622 can be implemented, for example, by display devices (e.g., a liquid crystal display, a cathode ray tube display (CRT), a printer and/or speakers). The interface circuit 1618, thus, typically includes a graphics driver card.

The interface circuit 1618 also includes a communication device such as a modem or network interface card to facilitate exchange of data with external computers via a network (e.g., an Ethernet connection, a digital subscriber line (DSL), a telephone line, coaxial cable, a cellular telephone system, etc.).

The computer 1600 also includes one or more mass storage devices 1626 for storing software and data. Examples of such mass storage devices 1626 include floppy disk drives, hard drive disks, compact disk drives and digital versatile disk (DVD) drives. The mass storage device 1626 may implement the offshore database 125.

Although certain example methods, apparatus, and articles of manufacture have been described herein, the scope of coverage of this patent is not limited thereto. On the contrary, this patent covers all methods, apparatus and articles of manufacture fairly falling within the scope of the appended claims either literally or under the doctrine of equivalents.

1. A method to manage offshore development resources comprising:
receiving a list of offshore resources for a project, the offshore resources accessible via an offshore module;
receiving export laws associated with the project;
determining offshore project requirements for the project based on the received export laws, the offshore project requirements compliant with the received export laws; and
communicating the offshore project requirements via the offshore module.

2. A method as defined in claim 1 wherein determining offshore project requirements comprises identifying export law constraints relevant to the project.

3. A method as defined in claim 2 further comprising downloading the export law constraints from a governmental entity.

4. (canceled)

5. (canceled)

6. A method as defined in claim 1 further comprising distributing the determined offshore project requirements to the offshore resources.

7. A method as defined in claim 1 wherein the offshore resources comprise at least one of an offshore business team, an application team, a vendor team, an export team, an information technology team, a security team, or a procurement team.

8-10. (canceled)

11. A method as defined in claim 1 wherein offshore resources for a project are identified by the offshore module.

12. A method as defined in claim 11 wherein the offshore module comprises at least one of a business module, an application team module, a vendor module, an export module, an information technology module, a security module, or a procurement module.

13. A method as defined in claim 12 wherein the offshore business module tracks offshore project requirement status information.

14. A method as defined in claim 12 wherein the application team module identifies vendor skill criteria.

15. A method as defined in claim 12 wherein the vendor module identifies skills of vendors in a vendor list.

16. A method as defined in claim 12 wherein the vendor module identifies training needs of the vendors in the vendor list.

17. A method as defined in claim 12 wherein the application team module receives vendor skill criteria from an offshore module.

18-20. (canceled)

21. A method as defined in claim 1 wherein the offshore module receives the offshore project data from the Internet.

22. An article of manufacture storing machine readable instructions which, when executed, cause a machine to:
receive a list of offshore resources for a project, the offshore resources accessible via an offshore module;
receive export laws associated with the project;
determine offshore project requirements for the project based on the received export laws, the offshore project requirements compliant with the received export laws; and
communicate the offshore project requirements via the offshore module.

23. An article of manufacture as defined in claim 22 wherein the machine readable instructions further cause the machine to identify export law constraints.

24. An article of manufacture as defined in claim 23 wherein the machine readable instructions further cause the machine to download the export law constraints from a governmental entity.

25. An article of manufacture as defined in claim 23 wherein the machine readable instructions further cause the machine to store the export law constraints in a database.

26. A method to manage offshore development resources comprising:
receiving offshore project objectives;
identifying offshore resource requirements to facilitate the project objectives;
receiving offshore vendor data indicative of the offshore resource requirements; and
selecting at least one vendor based on the received offshore vendor data.

27. A method as defined in claim 26 wherein the offshore resource requirements comprise at least one of vendor compliance with export laws, vendor skills, or vendor compliance with software license agreements.

28. A method as defined in claim 26 further comprising receiving at least one of the offshore project objectives or the offshore vendor data.

29. A method as defined in claim 28 further comprising storing the received at least one of the offshore project objectives or the offshore vendor data in a database.

30. A method as defined in claim 26 further comprising an export module to identify the offshore resource requirements and analyze the received offshore vendor data for compliance with the offshore resource requirements.

31-34. (canceled)

35. An offshore module comprising:
a business module to identify offshore project objectives;
an application team module to establish skill requirements necessary to accomplish the offshore project objectives;
a vendor module to identify, select, and track vendors having the necessary skill requirements for the offshore project objectives; and
an export module to identify export law constraints.

36. An offshore module as defined in claim 35 further comprising a graphical user interface to permit a user to access at least one of the business module, the application team module, the vendor module, or the export module.

37. (canceled)

38. An offshore module as defined in claim 35 further comprising a database to store at least one of offshore project objectives data, skill requirements data, vendor data, or export law data.

39. An offshore module as defined in claim 38 further comprising an export law update engine to extract export laws from an Internet source and store to the database.

40. A system for managing offshore development resources comprising:
an offshore module to communicate offshore project information between project managers and project workers;
a communication interface to facilitate receiving the offshore project information from the project managers and the project workers; and
an offshore database to store the offshore project information received by the project managers and the project workers.

41. A system as defined in claim 40 wherein the communication device provides offshore project information in response to a request from at least one of the project manager or the project worker.

42. A method to manage offshore development projects comprising:
connecting to an offshore module, the offshore module comprising a communication interface to authenticate an offshore project worker,
providing status information of the offshore development project to the offshore module; and
receiving offshore project assignment information from the offshore module.

43. A method as defined in claim 42 wherein the project assignment information comprises assignment information compliant with export law.

44. A system for managing offshore development resources comprising:
a database to store offshore project information;
a project manager communication interface to permit a project manager to add offshore project information to the database;
a project worker communication interface to permit a project worker to receive the offshore project information; and
an export module to identify data indicative of export regulation compliance with the offshore project information.

45. A system as defined in claim 44 further comprising a manager server to receive project instruction data from the project manager.

46. A system as defined in claim 45 wherein the manager server receives the data indicative of export regulation compliance.

47. A system as defined in claim 44 further comprising a vendor server to receive project update data from a vendor.

48. A system as defined in claim 47 further comprising a vendor communication interface to receive access requests from the vendor.

49. A system as defined in claim 47 further comprising a vendor user interface to receive offshore project status data from the project worker.

50. A system as defined in claim 44 further comprising an export server to apply export law constraints to the project information.

51. A system for managing offshore development resources comprising:
a business module to identify offshore project objectives;
an export module to determine compliance of the offshore project objectives with export regulations; and
a communication module to permit access to data indicative of the offshore project objectives and export regulations.

52. A user interface for an offshore project management tool comprising:
an offshore project description screen area to display at least one of offshore project objectives and offshore project resources; and
an export compliance description screen area to display offshore project compliance status information.
